(19) United States
(12) Patent Application Publication
(10) Pub. No.: US 2009/0047518 A1
(43) Pub. Date: Feb. 19, 2009

(54) POWDERY SILICA COMPOSITE PARTICLES, PROCESS OF PRODUCING SAME, SILICA COMPOSITE PARTICLE DISPERSION, AND RESIN COMPOSITION

(75) Inventors: Hideo Sawada, Aomori (JP); Masashi Sugiya, Tokyo (JP); Ryo Ebara, Tokyo (JP); Katsuhiko Tsunashima, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NIPPON CHEMICAL INDUSTRIAL CO., LTD., Tokyo (JP); NATIONAL UNIVERSITY CORPORATION HIROSAKI UNIVERSIT Y, Hirosaki-shi, Aomori (JP)

(21) Appl. No.: 12/282,314

(22) PCT Filed: Mar. 6, 2007
(86) PCT No.: PCT/JP2007/054246

§ 371 Date: Sep. 9, 2008

(30) Foreign Application Priority Data
Mar. 10, 2006 (JP) 2006-066579
Dec. 7, 2006 (JP) 2006-330376

(51) Int. Cl. B32B 1/00

(52) U.S. Cl. 428/405

(57) ABSTRACT

An object of the invention is to provide a substance enabling uniformly dispersing an ionic liquid or a phosphonium salt in various solvents, resin materials, and the like.

A powdery silica composite particle obtained by a surface treatment step comprising providing a reaction solution by mixing a silica sol containing a core silica particle having an average particle size of 5 to 200 nm, an alkoxysilane, and an ionic liquid and hydrolyzing the alkoxysilane by addition of an acid or an alkali to the reaction solution to surface-treat the core silica particle.

### TECHNICAL FIELD

This invention relates to surface-treated silica particles containing an ionic liquid or a phosphonium salt.

### BACKGROUND ART

An ionic liquid is a salt formed between a cation and an anion. It is liquid at ambient temperature and pressure and has no boiling point. Some ionic liquids have been studied from the early twentieth century for possible use in the field of electrochemistry but not for other applications.

With the increasing call for “green chemistry” in the 1990s, ionic liquids have been attracting attention because of their interesting properties such as incombustibility and nonvolatility. A variety of ionic liquids have thus been developed. In recent years, research has been progressing on the use of ionic liquids as incombustible, nonvolatile, and highly polar solvents.

However, applications of an ionic liquid other than as a solvent have not been developed. Development of a novel use of an ionic liquid is awaited.

A phosphonium salt represented by general formula (1):

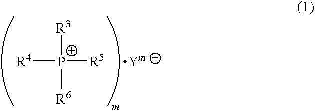

(wherein R³, R⁴, R⁵, and R⁶, which may be the same or different and may have part of the hydrogen atoms thereof substituted, each represent a straight-chain or branched alkyl group having 1 to 18 carbon atoms, a cycloalkyl group, or a phenyl group; m represents an integer 1 or 2; and Y represents an anion group)
   has antistatic properties and antimicrobial properties and is therefore useful as an antistatic agent or an antimicrobial agent. The phosphonium salt of general formula (1) also finds use as a reaction catalyst. Some of the phosphonium salts of general formula (1) are liquid and others solid at ambient temperature and pressure.

### DISCLOSURE OF THE INVENTION

### Problem to be Solved by the Invention

A functional material containing an ionic liquid is one of conceivable novel uses of an ionic liquid. An ionic liquid must be dispersed uniformly in a solvent, a resin material, etc. before an ionic liquid-containing functional material can be produced. The problem is that an ionic liquid, being liquid, is extremely difficult to disperse uniformly in a solvent, a resin material, etc.

Similarly to an ionic liquid, a functional material containing the phosphonium salt of general formula (1) is one of conceivable novel uses of the phosphonium salt. The phosphonium salt of general formula (1) must be dispersed uniformly in a solvent, a resin material, etc. before a functional material containing the phosphonium salt can be produced. The problem is that the phosphonium salts of general formula (1) which exhibit the ionic liquid property of being liquid at ambient temperature and pressure are extremely difficult to disperse uniformly in a solvent, a resin material, etc. similarly to an ionic liquid. On the other hand, the phosphonium salts of general formula (1) which are solid at ambient temperature and pressure are generally not only difficult to reduce to fine particles but also liable to agglomerate in a dispersion. Therefore, when they are dispersed in various solvents, resin materials, etc., the resulting dispersions tend to suffer from non-uniformity.

Accordingly, an object of the invention is to provide a substance enabling uniformly dispersing an ionic liquid or a phosphonium salt of general formula (1) in various solvents, resin materials, and the like.

### Means for Solving the Problem

To solve the above described problems of conventional techniques, the present inventors have conducted extensive researches and found, as a result, that (i) hydrolysis of an alkoxysilane in a reaction solution containing core silica particles having an average particle size of 5 to 200 nm, an alkoxysilane, and an ionic liquid or a phosphonium salt represented by general formula (1) by addition of an acid or an alkali yields powdery silica composite particles containing the ionic liquid or the phosphonium salt, (ii) because the powdery silica composite particles are fine solid particles each comprising a fine core silica particle having supported thereon the ionic liquid or the phosphonium salt of general formula (1), they are finely and uniformly dispersible in a solvent, a resin material, and the like, and (iii) further incorporating a fluoroalkyl-containing oligomer into the silica composite particles improves dispersibility and dispersion stability of the particles. The present invention has been completed based on these findings.

The invention provides:

(1) A powdery silica composite particle obtained by a surface treatment step comprising providing a reaction solution by mixing a silica sol containing a core silica particle having an average particle size of 5 to 200 nm, an alkoxysilane, and an ionic liquid and hydrolyzing the alkoxysilane by addition of an acid or an alkali to the reaction solution to surface-treat the core silica particle.
(2) A powdery silica composite particle obtained by a surface treatment step comprising providing a reaction solution by mixing a silica sol containing a core silica particle having an average particle size of 5 to 200 nm, an alkoxysilane, and a phosphonium salt represented by general formula (1):

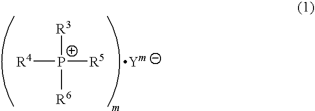

(wherein R³, R⁴, R⁵, and R⁶, which may be the same or different and may have part of the hydrogen atoms thereof substituted, each represent a straight-chain or branched alkyl group having 1 to 18 carbon atoms, a cycloalkyl group, or a phenyl group; m represents an integer 1 or 2; and Y represents an anion group, and hydrolyzing the alkoxysilane by addition of an acid or an alkali to the reaction solution to surface-treat the core silica particle)
   (3) The powdery silica composite particle described in (1) or (2) above, in which the reaction solution further contains a fluoroalkyl-containing oligomer represented by general formula (2):

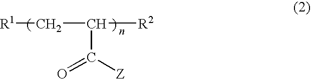

(wherein R¹ and R², which may be the same or different, each represent a —(CF₂)ₚ—X group or a —CF(CF₃)—[OCF₂CF(CF₃)]_{q}—OC₃F₇; X represents a hydrogen atom, a fluorine atom or a chlorine atom; p and q each represent an integer of 0 to 10; Z represents a hydroxyl group, a morpholino group, a tertiary amino group, or a secondary amino group; and n represents an integer of 5 to 1000)
   (4) A powdery silica composite particle comprising a core silica particle and an ionic liquid supported on the core silica particle. The powdery silica composite particle has an average particle size of 5 to 900 nm.
   (5) A powdery silica composite particle comprising a core silica particle and a phosphonium salt represented by general formula (1) supported on the core silica particle. The powdery silica composite particle has an average particle size of 5 to 900 nm.
   (6) A powdery silica composite particle comprising a core silica particle, an ionic liquid, and a fluoroalkyl-containing oligomer represented by general formula (2). Both the ionic liquid and the fluoroalkyl-containing oligomer are supported on the core silica particle. The powdery silica composite particle has an average particle size of 5 to 900 nm.
   (7) A powdery silica composite particle comprising a core silica particle, a phosphonium salt represented by general formula (2), and a fluoroalkyl-containing oligomer represented by general formula (2). Both the phosphonium salt and the fluoroalkyl-containing oligomer are supported on the core silica particle. The powdery silica composite particle has an average particle size of 5 to 900 nm.
   (8) A powdery silica composite particle comprising a core silica particle and a silica coating film formed on the core silica particle. The silica coating film contains an ionic liquid. The powdery silica composite particle has an average particle size of 5 to 900 nm.
   (9) A powdery silica composite particle comprising a core silica particle and a silica coating film formed on the core silica particle. The silica coating film contains a phosphonium salt represented by general formula (1). The powdery silica composite particle has an average particle size of 5 to 900 nm.
   (10) The powdery silica composite particle described in (8) or (9) above, in which the silica coating film further contains a fluoroalkyl-containing oligomer represented by general formula (2).
   (11) A process of producing a powdery silica composite particle. The process includes a surface treatment step comprising substeps of providing a reaction solution by mixing a silica sol containing a core silica particle having an average particle size of 5 to 200 nm, an alkoxysilane, and an ionic liquid and hydrolyzing the alkoxysilane by addition of an acid or an alkali to the reaction solution to surface-treat the core silica particle.
   (12) A process of producing a powdery silica composite particle. The process includes a surface treatment step comprising the substeps of providing a reaction solution by mixing a silica sol containing a core silica particle having an average particle size of 5 to 200 nm, an alkoxysilane, and a phosphonium salt represented by general formula (1) and hydrolyzing the alkoxysilane by addition of an acid or an alkali to the reaction solution to surface-treat the core silica particle.
   (13) The process of producing a powdery silica composite particle described in (11) or (12) above, in which the reaction solution further contains a fluoroalkyl-containing oligomer represented by general formula (2).
   (14) A silica composite particle dispersion comprising a solvent and the silica composite particle according to any one of the first to eighth aspects of the invention dispersed in the solvent.
   (15) A resin composition containing the silica composite particle according to any one of the first to eighth aspects of the invention.

### BEST MODE FOR CARRYING OUT THE INVENTION

A first embodiment of the powdery silica composite particle of the present invention is a powdery silica composite particle obtained by a surface treatment step comprising the substeps of providing a reaction solution by mixing a silica sol containing a core silica particle having an average particle size of 5 to 200 nm, an alkoxysilane, and an ionic liquid and hydrolyzing the alkoxysilane by addition of an acid or an alkali to the reaction solution to surface-treat the core silica particle. The powdery silica composite particle of the first embodiment will be referred to as a powdery silica composite particle(s) (1).

A second embodiment of the powdery silica composite particle of the invention is a powdery silica composite particle obtained by a surface treatment step comprising the substeps of providing a reaction solution by mixing a silica sol containing a core silica particle having an average particle size of 5 to 200 nm, an alkoxysilane, and a phosphonium salt represented by general formula (1) and hydrolyzing the alkoxysilane by addition of an acid or an alkali to the reaction solution to surface-treat the core silica particle. The powdery silica composite particle of the second embodiment will be referred to as a powdery silica composite particle(s) (2).

The surface treatment step involved in the production of the powdery silica composite particles (1) and (2) is a step of surface-treating the core silica particles by hydrolysis of an alkoxysilane.

Examples of the silica sol that can be used in the surface treatment include a silica sol in a hydrophilic solvent and a silica sol in a hydrophobic solvent. A methanol sol, an ethanol sol, and an isopropyl alcohol sol are preferred in view of ease of preparation for sol. A commercially available methanol sol may be made use of A hydrophobic solvent silica sol may be prepared by solvent displacement of an aqueous silica sol.

The core silica particles in the silica sol are silica particles made of SiO₂. The content of core silica in the silica sol is not particularly limited but preferably in the range of 1% to 80% by mass, more preferably 3% to 50% by mass.

The type of the core silica particles is not particularly limited and may be, for example, silica particles grown from a sodium silicate solution or an active silicic acid solution, silica particles prepared from an organosilicon compound, or fumed silica.

The core silica particles have an average particle size of 5 to 200 nm, preferably 8 to 100 nm. With the average particle size of the core silica particles being in the range recited, the resulting powdery silica composite particles have good dispersibility in a solvent or a resin material. A silica sol having core silica particles with the average particle size less than 5 nm is difficult to prepare. If the average particle size of the core silica exceeds 200 nm, the resulting powdery silica composite particles have reduced dispersion stability.

Examples of the alkoxysilane that is used for the surface treatment include tetramethoxysilane, tetraethoxysilane, methyltrimethoxysilane, methyltriethoxysilane, dimethyldimethoxysilane, dimethyldiethoxysilane, and hexyltrimethylsilane. Preferred of them are tetraethoxysilane and tetramethoxysilane in terms of ease of handling in their production. One or more than one alkoxysilanes may be used.

The ionic liquid concerning the powdery silica composite particle (1) is a salt that consists of a cation and an anion, is liquid at ambient temperature (25° C.) and ambient pressure (0.1 MPa), and has no boiling point. Any substances that satisfy the above characteristics can be used, including imidazolium salts, alkylpyridinium salts, alkylammonium salts, and phosphonium salts. Preferred of them are phosphonium salts in terms of providing powdery silica composite particles having high antistatic properties, antimicrobial properties, or catalytic properties. More preferred are the phosphonium salts represented by general formula (1) which exhibit the character of an ionic liquid, i.e., which is liquid at ambient temperature and pressure. The phosphonium salt may be a commercially available product or may be synthesized by known processes. That is, a phosphonium salt halide is synthesized from a trialkylphosphine and an alkyl halide, e.g., an alkyl chloride, and a desired phosphonium salt is obtained by replacing the anion of the phosphonium halide by double decomposition.

In general formula (1) representing the phosphonium salt concerning the powdery silica composite particles (2), R³, R⁴, R⁵, and R⁶ each represent a straight-chain or branched alkyl group having 1 to 18 carbon atoms, a cycloalkyl group, or a phenyl group. When R³, R⁴, R⁵, or R⁶ is a cycloalkyl group or a phenyl group, part of the hydrogen atom of the cycloalkyl ring or the benzene ring may be substituted with an alkyl group to form, e.g., a 4-methylcyclohexyl group or a 4-methylphenyl group. R³, R⁴, R⁵, and R⁶ may be the same or different. R³, R⁴, R⁵, and R⁶ may be a straight-chain or branched alkyl group having 1 to 18 carbon atoms, a cycloalkyl group, or a phenyl group, each having part of the hydrogen atoms thereof substituted with a hydroxyl group, an amino group, an alkoxy group, and so on.

In general formula (1) representing the phosphonium salt concerning the powdery silica composite particles (2), the number of the phosphonium groups, i.e., the number represented by m in

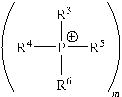

and the valence number of the anion group Y^{m-}, i.e., the number represented by m in Y^{m-} are equal. When the anion group Y^{m-} is monovalent (m=1), the number of the phosphonium group is 1. When the anion group Y^{m-} is divalent (m=2), the number of the phosphonium groups is 2. m is an integer of 1 or 2. Examples of the anion group Y^{m-} include monovalent groups such as a fluorine ion, a chloride ion, a bromine ion, an iodine ion, BF₄⁻, PF₆⁻, N(SO₂CF₃)₂⁻, PO₂(OMe)₂⁻, PS₂(OEt)₂⁻, and (CO₂Me)₂PhSO₃⁻; and divalent ones such as SO₄²⁻. The anion groups enumerated above are preferred in terms of ease of the preparation of the phosphonium salt.

The reaction solution concerning the powdery silica composite particles (1) is prepared by mixing a silica sol containing core silica particles, an alkoxysilane, and an ionic liquid in a solvent. The reaction solution concerning the powdery silica composite particles (2) is prepared by mixing a silica sol containing core silica particles, an alkoxysilane, and a phosphonium salt of general formula (1) in a solvent. The alkoxysilane and the ionic liquid or the phosphonium salt of general formula (1) are in a dissolved state in the solvent of the reaction solution, while the core silica particles in a dispersed state.

Accordingly, the solvent concerning the powdery silica composite particles (1) is one capable of dissolving both the alkoxysilane and the ionic liquid, such as methanol, ethanol, and isopropyl alcohol. Ethanol and methanol are preferred in terms of inexpensiveness, which is advantageous for production cost. The solvent concerning the powdery silica composite particles (2) is one capable of dissolving both the alkoxysilane and the phosphonium salt of general formula (1), such as methanol, ethanol, and isopropyl alcohol. Ethanol and methanol are preferred in terms of inexpensiveness, which is advantageous for production cost.

In the preparation of a reaction solution, the silica sol containing core silica particles, the alkoxysilane, and the ionic liquid or the phosphonium salt of general formula (1) may be added to the solvent in any order.

The amount of the core silica particles in the reaction solution is preferably, but not limited to, 1% to 80% by mass, more preferably 3% to 50% by mass. With the core silica particle content in the reaction solution being in that range, the resulting powdery silicon composite particles exhibit high dispersion stability.

The amount of the alkoxysilane in the reaction solution is 15 to 150 ml, preferably 30 to 105 ml, per 100 parts by mass of the core silica particles. With the alkoxysilane content in the reaction solution being in that range, the resulting powdery silica composite particles have an enhanced content of the ionic liquid or the phosphonium salt of general formula (1). When the alkoxysilane content in the reaction solution is less than 15 ml per 100 parts by mass of the core silica particles, the powdery silica composite particles tend to have a reduced amount of the ionic liquid. When it is more than 150 ml, the powdery silica composite particles tend to have reduced dispersion stability.

In the preparation of the powdery silica composite particles (1), the ionic liquid content in the reaction solution is 3 to 45 ml, preferably 6 to 30 ml, per 100 parts by mass of the core silica particles. With the ionic liquid content in the reaction solution being in that range, the resulting powdery silica composite particles have an enhanced content of the ionic liquid. When the ionic liquid content in the reaction solution is less than 3 ml per 100 parts by mass of the core silica particles, the powdery silica composite particles (1) tend to have a reduced ionic liquid content. Even when it is increased over 45 ml, the ionic liquid content will be saturated, which tends to result in inefficiency.

In the preparation of the powdery silica composite particles (2), the amount of the phosphonium salt of general formula (1) in the reaction solution is 3 to 45 ml, preferably 6 to 30 ml, per 100 parts by mass of the core silica particles in the case where the phosphonium salt is liquid at ambient temperature and pressure; or 2 to 50 parts by mass, preferably 5 to 40 parts by mass, per 100 parts by mass of the core silica particles in the case where the phosphonium salt is solid at ambient temperature and pressure. With the content of the phosphonium salt of general formula (1) being in the range recited, the resulting powdery silica composite particles (2) have an enhanced content of the phosphonium salt of general formula (1). When the content of the phosphonium salt of general formula (1) is less than the range recited, the powdery silica composite particles (2) tend to have a reduced content of the phosphonium salt of general formula (1). Even if it is increased over that range, the content of the phosphonium salt of general formula (1) will be saturated, which tends to cause inefficiency.

In the step of surface treatment, the acid or alkali that is added to the reaction solution is not limited as long as it induces hydrolysis of the alkoxysilane. Examples of the alkali are ammonium hydroxide, sodium hydroxide, and potassium hydroxide. Examples of the acid are sulfuric acid, hydrochloric acid, nitric acid, and acetic acid. In terms of high reactivity, ammonium hydroxide or hydrochloric acid is preferred, and ammonium hydroxide is more preferred.

The amount of the acid or alkali to be added is not particularly limited and is decided appropriately.

The reaction temperature of the alkoxysilane hydrolysis following the addition of an acid or an alkali is −5° C. to 50° C., preferably 0° C. to 30° C. If the reaction temperature is lower than −5° C., the rate of alkoxysilane hydrolysis is too low to achieve satisfactory reaction efficiency. If it exceeds 50° C., the resulting powdery silica composite particles tend to have reduced dispersion stability. The reaction time of the alkoxysilane hydrolysis following the addition of an acid or an alkali is not particularly limited and may be selected as appropriate. It is preferably 1 to 72 hours, more preferably 1 to 24 hours.

After completion of the surface treatment by the alkoxysilane hydrolysis following the addition of an acid or an alkali to the reaction solution, solid matter is separated from the reaction system by, for example, centrifugal separation. According to necessity, the collected solid is re-dispersed in a solvent, followed by centrifugation, and these operations are repeated a few times. Finally, the collected solid is dried to give powdery silica composite particles (1) or (2).

In the surface treatment step, the alkoxysilane is hydrolyzed into a polysiloxane compound which is a hydrolyzate of an alkoxysilane, which adheres to the surface of the core silica particles. In the meantime, part of the ionic liquid or the phosphonium salt of general formula (1) bonds firmly to the polysiloxane compound, forming a chemical bond or an intermolecular hydrogen bond, and the other part is incorporated into the network of the polysiloxane without forming a bond with the polysiloxane. Therefore, the ionic liquid or the phosphonium salt of general formula (1) includes the portion which exists via bonds on the surface of the polysiloxane compound adhering to the core silica particles and the portion which exists in the network of the polysiloxane compound.

As described, in the surface treatment step, the alkoxysilane hydrolyzate containing the ionic liquid or the phosphonium salt of general formula (1) adheres to the surface of the core silica particles to accomplish the surface treatment of the core silica particles.

In other words, the powdery silica composite particle (1) is a composite particle comprising a core silica particle and an alkoxysilane hydrolyzate containing an ionic liquid, and the powdery silica composite particle (2) is a composite particle comprising a core silica particle and an alkoxysilane hydrolyzate containing a phosphonium salt of general formula (1).

A third embodiment of the powdery silica composite particle according to the invention (hereinafter referred to as a powdery silica composite particle(s) (3)) is a particle obtained in the same manner as for the powdery silicon composite particle (1) or the powdery silicon composite particle (2), except that the reaction solution used in the surface treatment step further contains a fluoroalkyl-containing oligomer of general formula (2). The tertiary amino group as represented by Z in general formula (2) is exemplified by a trimethylamino group and a triethylamino group, and the secondary amino group as Z is exemplified by a —NHC(CH₃)₂CH₂COCH₃ group and a —NHCH(CH₃)₂ group. p and q in R¹ and R² is 0 to 10, preferably 0 to 8, more preferably 0 to 5.

That is, the powdery silica composite particle (3) is a powdery silica composite particle obtained by a surface treatment step comprising the substeps of providing a reaction solution by mixing a silica sol containing a core silica particle having an average particle size of 5 to 900 nm, an ionic liquid or a phosphonium salt of general formula (1), an alkoxysilane, and a fluoroalkyl-containing oligomer of general formula (2) and hydrolyzing the alkoxysilane by addition of an acid or an alkali to the reaction solution to surface-treat the core silica particle.

The solvent used to prepare a reaction solution concerning the powdery silica composite particles (3) is a solvent capable of dissolving all the ionic liquid or the phosphonium salt of general formula (1), the alkoxysilane, and the fluoroalkyl-containing oligomer of general formula (2). Examples of such a solvent include methanol, ethanol, and isopropyl alcohol.

The fluoroalkyl-containing oligomer of general formula (2) in the powdery silica composite particle (3) includes a first portion which on the surface of the polysiloxane compound (i.e., alkoxysilane hydrolyzate) adhering to the core silica particles, forming a chemical bond and an intermolecular hydrogen bond with the polysiloxane compound, and a second portion having part of the molecular chains thereof incorporated into the network of the polysiloxane compound. The molecular chains of the fluoroalkyl-containing oligomer of general formula (2) of the first portion which is bonded to the surface of the polysiloxane compound and the remainder of the molecular chains of the fluoroalkyl-containing oligomer of general formula (2) of the second portion which remain not incorporated into the polysiloxane compound network extend from the surface of the powdery silica composite particle (3), so that the molecular chains of the fluoroalkyl-containing oligomer of general formula (2) in the powdery silica composite particle (3) extend radially from the surface of the core silica particle like a corona.

When added to various solvents or resin materials, the powdery silica composite particles (3) are less likely to agglomerate each other because of the molecular chains of the fluoroalkyl-containing oligomer of general formula (2) extending from the surface of the individual core silica particles. Therefore, the powdery silica composite particles (3) exhibit further improved dispersibility and dispersion stability in various solvents or resin materials as compared with the powdery silica composite particles (1) and (2).

The amount of the fluoroalkyl-containing oligomer of general formula (2) in the reaction solution is preferably 5 to 90 parts by mass, more preferably 10 to 70 parts by mass, per 100 parts by mass of the core silica particles. With the content of the fluoroalkyl-containing oligomer of general formula (2) being in the range recited, the powdery silica composite particles (3) exhibit good dispersibility in various solvents or resin materials.

The fluoroalkyl-containing oligomer of general formula (2) can be prepared by reference to, for example, the processes taught in JP 11-246573A, JP 2001-253919A, and JP 2000-309594A.

For example, the fluoroalkyl-containing oligomer of general formula (2) is obtained from a fluoroalkanoyl peroxide compound represented by general formula (3):

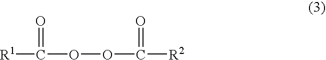

(wherein R¹ and R² are as defined for general formula (2)) and a compound having a vinyl group represented by general formula (4):

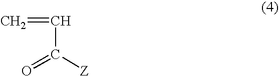

(wherein Z is as defined for general formula (2)) in accordance with reaction formula (5):

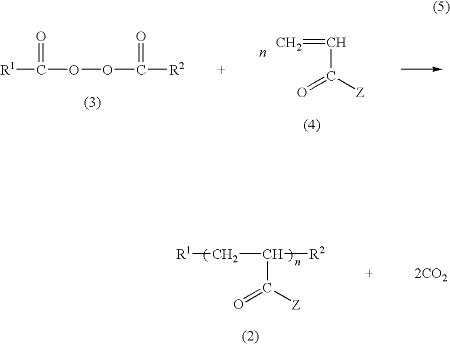

Examples of the fluoroalkanoyl peroxide compound of general formula (3) include diperfluoro-2-methyl-3-oxahexanoyl peroxide, diperfluoro-2,5-dimethyl-3,6-dioxanonanoyl peroxide, diperfluoro-2,5,8-trimethyl-3,6,9-trioxadodecanoyl peroxide, diperfluorobutyryl peroxide, diperfluoroheptanoyl peroxide, and diperfluorooctanoyl peroxide. These fluoroalkanoyl peroxide compounds of general formula (3) are easily obtainable by known processes, for example, by causing hydrogen peroxide to react with a fluoroalkyl-containing acyl halide in a fluorine-containing aromatic solvent or a fluorine-containing aliphatic solvent (e.g., a CFC's substitute) in the presence of an alkali such as sodium hydroxide, potassium hydroxide, potassium hydrogencarbonate, sodium carbonate, or potassium carbonate.

Examples of the compound having a vinyl compound represented by general formula (4) include acrylic acid, methacrylic acid, N-methyl(meth)acrylamide, N-methylacrylamide, N-ethyl(meth)acrylamide, N-ethylacrylamide, N-isopropyl(meth)acrylamide, N-isopropylacrylamide, N-n-propyl(meth)acrylamide, N-n-propylacrylamide, N-isobutyl(meth)acrylamide, N-n-butylacrylamide, N,N-dimethyl(meth)acrylamide, N,N-dimethylacrylamide, N,N-diethyl(meth)-acrylamide, N,N-diethylacrylamide, N,N-diisopropyl(meth)acrylamide, N,N-diisopropylacrylamide, N-acryloylmorpholine, and N-methacryloylmorpholine.

The reaction between the fluoroalkanoyl peroxide of general formula (3) and the compound having a vinyl group of general formula (4) is carried out, for example, as follows. The compound having a vinyl group of general formula (4) is dissolved in an inert solvent. The fluoroalkanoyl compound peroxide of general formula (3) is then mixed into the solution while stirring, and the temperature is elevated to 40° C. to 50° C., at which the reaction system is aged, followed by purification.

That is, the powdery silica composite particle (3) is a composite particle composed of a core silica particle and an alkoxysilane hydrolyzate containing a ionic liquid or a phosphonium salt of general formula (1) and a fluoroalkyl-containing oligomer of general formula (2).

The process of producing the first embodiment of the powdery silica composite particle according to the invention includes the surface treatment step for obtaining the powdery silica composite particle (1). The process of producing the second embodiment of the powdery silica composite particle according to the invention includes the surface treatment step for obtaining the powdery silica composite particle (2). The process of producing the third embodiment of the powdery silica composite particle according to the invention includes the surface treatment step for obtaining the powdery silica composite particle (3).

A fourth embodiment of the powdery silica composite particle according to the invention (hereinafter referred to as a powdery silica composite particle(s) (4)) comprises a core silica particle and an ionic liquid supported on the core silica particle and has an average particle size of 5 to 900 nm.

A fifth embodiment of the powdery silica composite particle according to the invention comprises (hereinafter referred to as a powdery silica composite particle(s) (5)) a core silica particle and a phosphonium salt represented by general formula (1) supported on the core silica particle and has an average particle size of 5 to 900 nm.

A sixth embodiment of the powdery silica composite particle according to the invention (hereinafter referred to as a powdery silica composite particle(s) (6)) is the powdery silica composite particle (4) which further has a fluoroalkyl-containing oligomer of general formula (2) supported in addition to the ionic liquid. That is, the powdery silica composite particle (6) comprises a core silica particle and an ionic liquid and a fluoroalkyl-containing oligomer of general formula (2) both supported on the core silica particle and has an average particle size of 5 to 900 nm.

A seventh embodiment of the powdery silica composite particle according to the invention (hereinafter referred to as a powdery silica composite particle(s) (7)) is the powdery silica composite particle (5) further having a fluoroalkyl-containing oligomer of general formula (2) supported in addition to the phosphonium salt of general formula (1). That is, the powdery silica composite particle (7) comprises a core silica particle and a phosphonium salt of general formula (2) and a fluoroalkyl-containing oligomer of general formula (2) both supported on the core silica particle and has an average particle size of 5 to 900 nm.

In the powdery silica composite particles (4), (5), (6), or (7), each of the ionic liquid, the phosphonium salt of general formula (1), and the fluoroalkyl-containing oligomer of general formula (2) includes a portion which exists, via a chemical bond and an intermolecular hydrogen bond, on an intermediary substance adhering to the surface of the core silica particle and a portion which exists as incorporated into the intermediary substance. To put it another way, each of the ionic liquid, the phosphonium salt of general formula (1), and the fluoroalkyl-containing oligomer of general formula (2) includes a portion which exists on the surface of the powdery silica composite particle (4), (5), (6), or (7) and a portion which exists inside the intermediary substance.

As described, the ionic liquid, the phosphonium salt of general formula (1), and the fluoroalkyl-containing oligomer of general formula (2) are supported on the core silica particle via an intermediary substance. Examples of the intermediary substance include a hydrolyzate of an alkoxysilane, an active sol, and silicon oxide (SiO₂) such as water glass. Titanium oxide (TiO₂) is also included.

The ionic liquid, the phosphonium salt of general formula (1), the fluoroalkyl-containing oligomer of general formula (2), the core silica particle, the alkoxysilane, and the alkoxysilane hydrolyzate concerning the powdery silica composite particles (4), (5), (6), and (7) are the same as those concerning the powdery silica composite particles (1), (2), and (3).

The method of supporting the ionic liquid, the phosphonium salt of general formula (1), or the fluoroalkyl-containing oligomer of general formula (2) on the core silica particle in the powdery silica composite particles (4), (5), (6) and (7) is exemplified by the surface treatment step that is carried out in the production of the powdery silica composite particles (1), (2), or (3).

Accordingly, the powdery silica composite particle (4) is a composite particle comprising a core silica particle, an intermediary substance, and an ionic liquid supported on the core silica particle via the intermediary substance. The powdery silica composite particle (5) is a composite particle comprising a core silica particle, an intermediary substance, and a phosphonium salt of general formula (1) supported on the core silica particle via the intermediary substance. The powdery silica composite particle (6) is a composite particle comprising a core silica particle, an intermediary substance, and an ionic liquid and a fluoroalkyl-containing oligomer of general formula (2) both supported on the core silica particle via the intermediary substance. The powdery silica composite particle (7) is a composite particle comprising a core silica particle, an intermediary substance, and a phosphonium salt of general formula (1) and a fluoroalkyl-containing oligomer of general formula (2) both supported on the core silica particle via the intermediary substance.

The powdery silica composite particles (6) and (7) have a part or all of the molecular chains of the fluoroalkyl-containing oligomer extending radially from the surface of the core silica particle like a corona similarly to the powdery silica composite particle (3).

An eighth embodiment of the powdery silica composite particle according to the invention (hereinafter referred to as a powdery silica composite particle(s) (8)) comprises a core silica particle and a silica coating film formed on the core silica particle. The silica coating film contains an ionic liquid. The powdery silica composite particle (8) has an average particle size of 5 to 900 nm.

A ninth embodiment of the powdery silica composite particle according to the invention (hereinafter referred to as a powdery silica composite particle(s) (9) comprises a core silica particle and a silica coating film formed on the core silica particle. The silica coating film contains a phosphonium salt represented by general formula (1). The powdery silica composite particle (9) has an average particle size of 5 to 900 nm.

A tenth embodiment of the powdery silica composite particle according to the invention (hereinafter referred to as a powdery silica composite particle(s) (10)) is the powdery silica composite particle (8) or (9), in which the silica coating film further contains a fluoroalkyl-containing oligomer of general formula (2). That is, the powdery silica composite particle (10) comprises a core silica particle and a silica coating film formed on the core silica particle, the silica coating film containing an ionic liquid or a phosphonium salt of general formula (1) and a fluoroalkyl-containing oligomer of general formula (2), and has an average particle size of 5 to 900 nm.

The silica coating film of the powdery silica composite particles (8), (9), and (10) is formed of, for example, a polysiloxane.

The silica coating film of the powdery silica composite particles (8), (9), and (10) is formed by, for example, depositing a hydrolyzate of an alkoxysilane on the surface of the core silica particle.

The silica coating film of the powdery silica composite particle (8) contains the ionic liquid. The silica coating film of the powdery silica composite particle (9) contains the phosphonium salt of general formula (1). The silica coating film of the powdery silica composite particle (10) contains the ionic liquid or the phosphonium salt of general formula (1) and the fluoroalkyl-containing oligomer of general formula (2).

The method of forming an ionic liquid-containing silica coating film on the surface of core silica particles to provide the powdery silica composite particles (8) is exemplified by the surface treatment step that is carried out in the production of the powdery silica composite particles (1). The method of forming a silica coating film containing the phosphorous salt of general formula (1) on the surface of core silica particles to provide the powdery silica composite particles (9) is exemplified by the surface treatment step that is carried out in the production of the powdery silica composite particles (2). The method of forming a silica coating film containing an ionic liquid or the phosphorous salt of general formula (1) and the fluoroalkyl-containing oligomer of general formula (2) on the surface of core silica particles to provide the powdery silica composite particles (10) is exemplified by the surface treatment step that is carried out in the production of the powdery silica composite particles (3).

The ionic liquid, the phosphonium salt of general formula (1), the fluoroalkyl-containing oligomer of general formula (2), the core silica particles, the alkoxysilane, and the alkoxysilane hydrolyzate concerning the powdery silica composite particles (8), (9), and (10) are the same as those concerning the powdery silica composite particles (1), (2), and (3).

Accordingly, the powdery silica composite particle (8) is a composite particle comprising a core silica particle and an ionic liquid-containing silica coating film. The powdery silica composite particle (9) is a composite particle comprising a core silica particle and a silica coating film containing a phosphonium salt of general formula (1). The powdery silica composite particle (10) is a composite particle comprising a core silica particle and a silica coating film containing an ionic liquid or a phosphonium salt of general formula (1) and a fluoroalkyl-containing oligomer of general formula (2).

The powdery silica composite particle (10) has a part or all of the molecular chains of the fluoroalkyl-containing oligomer of general formula (2) extending radially from the surface of the core silica particle like a corona similarly to the powdery silica composite particle (3).

The powdery silica composite particles (1) to (10) have an average particle size of 5 to 900 nm, preferably 10 to 600 nm. The powdery silica composite particles (1) to (10) with an average particle size smaller than 5 nm are difficult to make. The powdery silica composite particles (1) to (10) with an average particle size greater than 900 nm have reduced dispersion stability.

The content of the fluoroalkyl-containing oligomer of general formula (2) in the powdery silica composite particles (3), (6), (7), and (10) is preferably 5% to 90% by mass, more preferably 10% to 70% by mass. With the content of the fluoroalkyl-containing oligomer of general formula (2) in the powdery silica composite particles (3), (6), (7), and (10) falling within the range recited, the powdery silica composite particles (3), (6), (7), and (10) have high dispersibility in various solvents or resin materials.

The average particle sizes of the core silica particles and the powdery silica composite particles (1) to (10) as referred to in the description are values measured with a light scattering photometer.

The existence of an ionic liquid in the powdery silica composite particles (1), (3), (4), (6), (8), and (10) can be confirmed by detecting an atom derived only from the ionic liquid by ICP-AES. The content of the ionic liquid in the powdery silica composite particles (1), (3), (4), (6), (8), and (10) is calculated from the content of the atom derived only from the ionic liquid as determined by ICP-AES. The atom derived only from the ionic liquid may be of either the anion or the cation constituting the ionic liquid.

The existence of the phosphonium salt of general formula (1) in the powdery silica composite particles (2), (3), (5), (7), (9), and (10) can be confirmed by detecting a phosphorus atom by ICP-AES. The content of the phosphonium salt of general formula (1) in the powdery silica composite particles (2), (3), (5), (7), (9), and (10) is calculated from the phosphorus content measured by ICP-AES.

The existence of the fluoroalkyl-containing oligomer of general formula (2) in the powdery silica composite particles (3), (6), (7), and (10) can be confirmed by detecting a fluorine atom by elemental analysis. The content of the fluoroalkyl-containing oligomer of general formula (2) in the powdery silica composite particles (3), (6), (7), and (10) is calculated from the fluorine atom content measured by elemental analysis.

The silica composite particle dispersion according to the invention comprises the powdery silica composite particle (1), (2), (3), (4), (5), (6), (7), (8), (9), or (10) dispersed in a solvent. The powdery silica composite particles (1), (2), (3), (4), (5), (6), (7), (8), (9), and (10) may be used either individually or as a combination of two or more thereof.

The solvent that is used in the silica composite particle dispersion of the invention may be water or an organic solvent. The organic solvent may be either polar or non-polar. Examples of the organic solvent include polar solvents such as methanol, ethanol, and isopropyl alcohol and non-polar solvents such as hexane.

The silica composite particle dispersion of the invention is prepared by putting the powdery silica composite particles (1), (2), (3), (4), (5), (6), (7), (8), (9), or (10) into a solvent of choice and dispersed therein by, for example, stirring.

The resin composition according to the present invention contains the powdery silica composite particles (1), (2), (3), (4), (5), (6), (7), (8), (9), or (10). In other words, the resin composition of the invention comprises a resin and the powdery silica composite particles (1), (2), (3), (4), (5), (6), (7), (8), (9), or (10) dispersed in the resin. The powdery silica composite particles may be used either individually or as a combination of two or more thereof.

The resin in which the powdery silica composite particles (1), (2), (3), (4), (5), (6), (7), (8), (9), or (10) are to be dispersed is not limited and exemplified by polyethylene and polymethyl methacrylate.

The resin composition of the invention is prepared by mixing the powdery silica composite particles (1), (2), (3), (4), (5), (6), (7), (8), (9), or (10) with a resin of choice and dispersed by, for example, melt blending.

It is difficult to totally uniformly disperse an ionic liquid as it is in various solvents or resin materials. If an ionic liquid is dispersed as it is, the resulting dispersion tends to suffer from non-uniformity. Furthermore, the individual droplets of an ionic liquid as dispersed in various solvents or resin materials have a large volume because of the difficulty in reducing the droplet size. When a solvent or a resin material having ionic liquid droplets dispersed therein is observed in small units, there is noticeable non-uniformity in amount of the ionic liquid among the units. That is, dispersions of an ionic liquid per se in various solvents or resin materials suffer from considerable non-uniformity as observed both totally and locally.

According to the present invention, in contrast, when the powdery silica composite particles (1) to (10) are dispersed in various solvents or resin materials, the ionic liquid is dispersed as supported on a solid carrier, i.e., core silica particles and is therefore more dispersible than the ionic liquid per se. That is, the powdery silica composite particles (1) to (10) achieve improved total dispersibility of the ionic liquid in various solvents or resin materials. Since the particle size of the powdery silica composite particles (1) to (10) is extremely as small as 5 to 900 nm, the ionic liquid can be dispersed more uniformly as observed in small units than when the ionic liquid is dispersed as it is. In short, the powdery silica composite particles (1) to (10) enable finely and uniformly dispersing an ionic liquid to provide an ionic liquid dispersion with little non-uniformity as observed either totally or locally.

Being liquid, an ionic liquid is instable in various solvents or resin materials. After dispersed in a solvent or a resin material, the dispersed droplets of the ionic liquid gather into a greater droplet. The non-uniformity of a dispersion of an ionic liquid per se in a solvent or a resin material aggravates with time.

In contrast, the powdery silica composite particles (3), (6), (7), and (10) are less liable to agglomerate after being dispersed in a solvent or a resin material because a part or the whole of the individual molecular chains of the fluoroalkyl-containing oligomer of general formula (2) are extending from the surface of the particles. To be brief, the powdery silica composite particles (3), (6), (7), and (10) exhibit good dispersibility and high dispersion stability.

The same observation is equally true of the dispersibility of the phosphonium salt of general formula (1) which is liquid at ambient temperature and pressure. In brief, the powdery silica composite particles (1) to (10) enable finely and uniformly dispersing a phosphonium salt of general formula (1) which is liquid at ambient temperature and pressure in various solvents or resin materials to provide phosphonium salt dispersions with little non-uniformity as observed either totally or locally as compared with when the phosphonium salt is dispersed as it is liquid in various solvents or resin materials, and the powdery silica composite particles (3), (6), (7), and (10) exhibit good dispersibility and high dispersion stability.

The phosphonium salt of general formula (1) which is solid at ambient temperature and pressure is, in general, not only difficult to reduce into fine particles but also liable to agglomerate in a dispersion. Therefore, when it is dispersed in various solvents or resin materials, the resulting dispersions tend to suffer from non-uniformity.

In contrast, the powdery silica composite particles (1) to (10) enable finely and uniformly dispersing a phosphonium salt of general formula (1) to provide a phosphonium salt dispersion with little non-uniformity as observed either totally or locally, and the powdery silica composite particles (3), (6), (7), and (10) exhibit good dispersibility and high dispersion stability.

Thus, a material having an ionic liquid or a phosphonium salt of general formula (1) finely and uniformly dispersed can be obtained by using the powdery silica composite particles (1) to (10).

Since the phosphonium salt of general formula (1) has antistatic properties and antimicrobial properties and so on, functional materials having antistatic properties and antimicrobial properties can be provided by using the powdery silica composite particles (2), (3), (5), (7), (9), and (10). Additionally, the phosphonium salt of general formula (1) also functions as a reaction catalyst and exhibits high heat resistance, high catalytic activity, and reaction selectivity. Therefore, the powdery silica composite particles (2), (3), (5), (7), (9), and (10) provide a catalyst system that allows for easy recovery of the phosphonium salt of general formula (1) after reaction.

The present invention will now be illustrated in greater detail with reference to Examples, but it should be understood that they are for illustrative purposes only but not for limiting the invention.

### EXAMPLES

### Synthesis Example 1

In a 1-liter three-necked flask were put 29.4 g (0.41 mol) of acrylic acid and 500 ml of AK-225 (incombustible, fluorocarbon solvent mixture represented by CF₃CF₂CHCl₂/CClF₂CF₂CHClF, available from Asahi Glass Co., Ltd.). In the flask was further put 334 g of a 10% AK-225 solution of perfluoro-2-methyl-3-oxahexanoyl peroxide ([C₃F₇—O—CF(CF₃)—CO—O—]₂, 0.05 mol) at room temperature. The reaction system was heated up to 45° C. while stirring. After aging for 5 hours at that temperature, the stirring was stopped, and the reaction system was allowed to stand overnight, followed by concentration. The concentrate was washed with AK-225 and filtered. The filter cake was dried in vacuo at 50° C. to give an oligomer (designated RF-ACA). The details of the resulting oligomer are shown in Table 1 below.

### Synthesis Example 2

An oligomer designated RF-DOBAA was obtained in the same manner as in Synthesis Example 1, except for replacing 29.4 g of acrylic acid with 69.3 g (0.41 mol) of diacetoneacrylamide. The details of the oligomer are shown in Table 1.

### Synthesis Example 3

An oligomer designated RF-DMAA was obtained in the same manner as in Synthesis Example 1, except for replacing 29.4 g of acrylic acid with 42.6 g (0.41 mol) of dimethylacrylamide. The details of the oligomer are shown in Table 1.

TABLE 1

| | Synthesis Example 1 | Synthesis Example 2 | Synthesis Example 3 |
|---|---|---|---|
| R¹ | —CF(CF₃)OC₃F₇ | —CF(CF₃)OC₃F₇ | —CF(CF₃)OC₃F₇ |
| R² | —CF(CF₃)OC₃F₇ | —CF(CF₃)OC₃F₇ | —CF(CF₃)OC₃F₇ |
| Z | —OH | —NHC(CH₃)₂CH₂COCH₃ | —N(CH₃)₂ |
| Molecular | 2770 | 15341 | 4817 |
| Weight* | | | |
| Oligomer | RF-ACA | RF-DOBAA | RF-DMAA |
| Designation | | | |

*Polystyrene equivalent number-average molecular weight measured by gel permeation chromatography.

Chemical formulae of the ionic liquids used in Examples are shown below.

Ionic liquid A: [(C₄H₉)₃P(C₈H₁₇)]⁺(CF₃SO₂)₂N⁻
Ionic liquid B: [(C₄H₉)₃P(C₈H₁₇)]⁺BF₄⁻
Ionic liquid C:

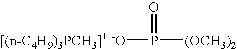

Ionic liquid D: [(C₄H₉)₃P(C₈H₁₇)]⁺PF₆⁻
Ionic liquid E:

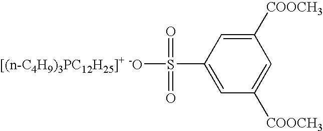

Ionic liquid F:

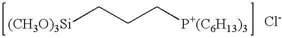

Ionic liquid G: [(n-C₄H₉)₃PCH₂CH₂OH]⁺Cl⁻
Ionic liquid H:

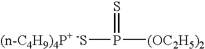

### Example 1

In a 50 ml sample bottle were put 20 ml of methanol, and 0.5 ml of ionic liquid E, 3.3 g of a silica sol (a 30% methanol solution, available from Nissan Chemical Industries, Ltd.; SiO₂ content: 1.0 g; particle size: 10-20 nm), and 2.3 ml of tetraethoxysilane (T0100 available from Tokyo Chemical Industry Co., Ltd.) were then added, followed by stirring to mix them. While thoroughly stirring, 0.5 ml of 25% aqueous ammonia was added. The reaction system was stirred overnight and concentrated to solid, which was dispersed in methanol by stirring overnight, followed by centrifugation. The operation of dispersing the solid in methanol by stirring overnight, followed by centrifugation was repeated twice. The thus purified solid was dried in vacuo in a vacuum desiccator to give powdery silica composite particles. The phosphorus content in the powdery silica composite particles was measured by ICP-AES. The powdery silica composite particles were dispersed in methanol by stirring for 24 hours to prepare a sample (A). The average dispersed particle size in the sample (A) was measured with a light scattering photometer. As a result, the yield was 25 mass %, and the average particle size was 109.7±22.8 nm.

### Example 2

Powdery silica composite particles were obtained in the same manner as in Example 1, except for replacing 0.5 ml of ionic liquid E with 0.5 ml of ionic liquid H. The yield was 44 mass %, the P content was 0.06 mass %, and the average particle size was 45.2±10.17 nm. FIG. 1 shows the particle size distribution of the resulting powdery silica composite particles.

### Example 3

In a 50 ml sample bottle were put 20 ml of methanol, and 0.5 ml of ionic liquid F, 0.5 g of RF-DOBAA (oligomer obtained in Synthesis Example 2), 3.33 g of the same silica sol as used in Example 1 (SiO₂ content: 1.0 g), and 2.3 ml of the same tetraethoxysilane as used in Example 1 were then added, followed by stirring to mix them. While thoroughly stirring, 0.5 ml of 25% aqueous ammonia was added. The reaction system was stirred overnight and concentrated to solid, which was dispersed in methanol by stirring overnight, followed by centrifugation. The operation of dispersing the solid in methanol by stirring overnight, followed by centrifugation was repeated twice. The thus purified solid was dried in vacuo in a vacuum desiccator to give powdery silica composite particles. The phosphorus content in the powdery silica composite particles was measured by ICP-AES. The fluorine content in the powdery silica composite particles was measured by elemental analysis. The powdery silica composite particles were dispersed in methanol by stirring for 24 hours to prepare a sample (A). The average dispersed particle size was measured with a light scattering photometer. As a result, the yield was 38.10 mass %, the P content 0.34 mass %, the F content 1.29 mass %, and the average particle size 82.9±8.2 nm.

### Example 4

Powdery silica composite particles were obtained in the same manner as in Example 3, except for replacing 0.5 ml of ionic liquid F with 0.5 ml of ionic liquid H. The yield was 23.51 mass %, the P content 0.077 mass %, the F content 2.18 mass %, and the average particle size 27.1±16.4 nm.

### Example 5

Powdery silica composite particles were obtained in the same manner as in Example 3, except for replacing 0.5 ml of ionic liquid F with 0.5 ml of ionic liquid C. The yield was 34.39 mass %, the P content 0.14 mass %, and the average particle size 27.1±1.7 nm.

### Example 6

Powdery silica composite particles were obtained in the same manner as in Example 3, except for replacing 0.5 ml of ionic liquid F with 0.5 ml of ionic liquid E. The yield was 43.69 mass %, the P content 0.059 mass %, the F content 0.35 mass %, and the average particle size 45.0±10.7 nm.

### Example 7

Powdery silica composite particles were obtained in the same manner as in Example 3, except for replacing 0.5 ml of ionic liquid F with 0.5 ml of ionic liquid A. The yield was 20.56 mass %, the P content 0.083 mass %, the F content 1.87 mass %, and the average particle size 52.1±6.5 nm.

### Example 8

Powdery silica composite particles were obtained in the same manner as in Example 3, except for replacing 0.5 ml of ionic liquid F with 0.5 ml of ionic liquid D. The yield was 17.43 mass %, the P content 0.13 mass %, and the average particle size 51.2±0.0 nm.

### Example 9

Powdery silica composite particles were obtained in the same manner as in Example 3, except for replacing 0.5 ml of ionic liquid F with 0.5 ml of ionic liquid D and replacing 0.5 g of RF-DOBAA oligomer with 0.5 g of RF-ACA oligomer obtained in Synthesis Example 1. The yield was 8.01 mass % and the average particle size was 57.6±9.0 nm.

### Example 10

Powdery silica composite particles were obtained in the same manner as in Example 3, except for replacing 0.5 ml of ionic liquid F with 0.5 ml of ionic liquid H and replacing 0.5 g of RF-DOBAA oligomer with 0.5 g of RF-ACA oligomer obtained in Synthesis Example 1. The yield was 58.27 mass %, the P content 0.60 mass %, the F content 0.86 mass %, and the average particle size 44.6±9.0 nm.

### Example 11

Powdery silica composite particles were obtained in the same manner as in Example 3, except for replacing 0.5 ml of ionic liquid F with 0.5 ml of ionic liquid C and replacing 0.5 g of RF-DOBAA oligomer with 0.5 g of RF-ACA oligomer obtained in Synthesis Example 1. The yield was 41.58 mass %, the P content 0.54 mass %, and the average particle size 46.2±6.1 nm.

### Example 12

Powdery silica composite particles were obtained in the same manner as in Example 3, except for replacing 0.5 ml of ionic liquid F with 0.5 ml of ionic liquid E and replacing 0.5 g of RF-DOBAA oligomer with 0.5 g of RF-ACA oligomer obtained in Synthesis Example 1. The yield was 53.15 mass %, the P content 0.14 mass %, the F content 0.94 mass %, and the average particle size 37.4±4.3 nm.

### Example 13

Powdery silica composite particles were obtained in the same manner as in Example 3, except for replacing 0.5 ml of ionic liquid F with 0.5 ml of ionic liquid H and replacing 0.5 g of RF-DOBAA oligomer with 0.5 g of RF-DMAA oligomer obtained in Synthesis Example 3. The yield was 55.08 mass %, the P content 0.25 mass %, the F content 0.59 mass %, and the average particle size 44.7±0.0 nm.

### Example 14

Powdery silica composite particles were obtained in the same manner as in Example 3, except for replacing 0.5 ml of ionic liquid F with 0.5 ml of ionic liquid C and replacing 0.5 g of RF-DOBAA oligomer with 0.5 g of RF-DMAA oligomer obtained in Synthesis Example 3. The yield was 57.75 mass %, the P content 0.17 mass %, and the average particle size 50.1±6.0 nm.

### Example 15

Powdery silica composite particles were obtained in the same manner as in Example 3, except for replacing 0.5 ml of ionic liquid F with 0.5 ml of ionic liquid E and replacing 0.5 g of RF-DOBAA oligomer with 0.5 g of RF-DMAA oligomer obtained in Synthesis Example 3. The yield was 51.86 mass %, the P content 0.044 mass %, the F content 0.52 mass %, and the average particle size 124.4±23.5 nm.

### Dispersibility Test

The powdery silica composite particles obtained in Examples 1 to 10 and 13 were tested for dispersibility in accordance with the following procedures. The results obtained are shown in Table 2.

### Test 1:

After the measurement of average dispersed particle size in each Example, the sample (A) was dried in vacuo to remove methanol. The particles were again dispersed in methanol by stirring for 24 hours to prepare a sample (B). The average dispersed particle size of the sample (B) was measured.

### Test 2:

After the measurement of average dispersed particle size of the sample (B) in test 1, the sample (B) was dried in vacuo to remove methanol. The particles were dispersed in water by stirring for 24 hours to prepare a sample (C). The average dispersed particle size of the sample (C) was measured.

### Test 3:

After the measurement of average dispersed particle size of the sample (C) in test 2, the sample (C) was dried in vacuo to remove water. The particles were dispersed in tetrahydrofuran (THF) by stirring for 24 hours to prepare a sample (D). The average dispersed particle size of the sample (D) was measured.

TABLE 2

| | Average Dispersed Particle Size (nm) | | |
|---|---|---|---|
| Example No. | Test 1 | Test 2 | Test 3 |
| 1 | 109.7 ± 22.8 | — | — |
| 2 | 45.0 ± 10.7 | 25.3 ± 3.1 | — |
| 3 | 82.6 ± 7.8 | 58.1 ± 7.1 | — |
| 4 | 42.9 ± 4.4 | 35.5 ± 2.2 | — |
| 5 | 88.2 ± 12.5 | 55.7 ± 5.9 | — |
| 6 | 25.3 ± 3.1 | 28.5 ± 3.1 | — |
| 7 | 86.8 ± 11.9 | 34.1 ± 0.0 | — |
| 8 | 51.2 ± 0.0 | 57.9 ± 8.9 | — |
| 9 | 55.4 ± 6.5 | 47.6 ± 5.6 | 55.6 ± 7.9 |
| 10 | 42.7 ± 4.3 | 38.3 ± 4.5 | 63.7 ± 6.9 |
| 13 | 38.0 ± 4.5 | 42.3 ± 4.1 | 85.5 ± 9.7 |

### Example 16

In a 50 ml bottle were put 20 ml of methanol, and 0.5 ml of ionic liquid A, 3.33 g of a silica sol (a 30% methanol solution, available from Nissan Chemical Industries, Ltd.; SiO₂ content: 1.0 g; particle size: 10-20 nm), and 2.3 mmol of tetraethoxysilane (T0100 available from Tokyo Chemical Industry Co., Ltd.) were then added, followed by stirring to mix them. While thoroughly stirring, 0.5 ml of 25% aqueous ammonia was added. The reaction system was stirred overnight and concentrated to solid, which was dispersed in methanol by stirring overnight, followed by centrifugation. The operation of dispersing the solid in methanol by stirring overnight, followed by centrifugation was repeated twice. The thus purified solid was dried in vacuo in a vacuum desiccator to give powdery silica composite particles. The yield was 28 mass %. The phosphorus content in the powdery silica composite particles was 0.07 mass % as measured by ICP-AES. The powdery silica composite particles were dispersed in methanol by stirring for 24 hours to provide a sample (A). The average dispersed particle size of the sample (A) was 69.8±30.2 nm as measured with a light scattering photometer. The powdery silica composite particles and, for comparison, silica powder (1) and ionic liquid A were analyzed by thermogravimetry. The results obtained are shown in FIG. 2. The weight losses of the powdery silica composite particles and the silica powder (1) at 800° C. were 5.4% and 8.2%, respectively.

### Example 17

Powdery silica composite particles were obtained in the same manner as in Example 16, except for replacing 0.5 ml of ionic liquid A with 0.5 ml of ionic liquid B. As a result, the yield was 57 mass %, the P content 0.09 mass %, and the average particle size 193.2±46.9 nm. The powdery silica composite particles and, for comparison, silica powder (1) and ionic liquid B were analyzed by thermogravimetry. The results obtained are shown in FIG. 3. The weight losses of the powdery silica composite particles and the silica powder (1) at 800° C. were 5.8% and 8.2%, respectively.

### Example 18

Powdery silica composite particles were obtained in the same manner as in Example 16, except for replacing 0.5 ml of ionic liquid A with 0.5 ml of ionic liquid C. As a result, the yield was 63 mass %, the P content 0.23 mass %, and the average particle size 109.6±25.9 nm. The powdery silica composite particles and, for comparison, silica powder (1) and ionic liquid C were analyzed by thermogravimetry. The results obtained are shown in FIG. 4. The weight losses of the powdery silica composite particles and the silica powder (1) at 800° C. were 5.2% and 8.2%, respectively.

### Example 19

Powdery silica composite particles were obtained in the same manner as in Example 16, except for replacing 0.5 ml of ionic liquid A with 0.5 ml of ionic liquid D. As a result, the yield was 42 mass %, the P content 0.40 mass %, and the average particle size 248.0±55.0 nm. The powdery silica composite particles and, for comparison, silica powder (1) and ionic liquid D were analyzed by thermogravimetry. The results obtained are shown in FIG. 5. The weight losses of the powdery silica composite particles and the silica powder (1) at 800° C. were 6.0% and 8.2%, respectively.

### Example 20

Powdery silica composite particles were obtained in the same manner as in Example 16, except for replacing 0.5 ml of ionic liquid A with 0.5 ml of ionic liquid E. As a result, the yield was 29 mass %, the P content 0.16 mass %, and the average particle size 142.7±36.1 nm. The powdery silica composite particles and, for comparison, silica powder (1) and ionic liquid E were analyzed by thermogravimetry. The results obtained are shown in FIG. 6. The weight losses of the powdery silica composite particles and the silica powder (1) at 800° C. were 5.7% and 8.2%, respectively. Furthermore, the powdery silica composite particles were observed under a transmission electron microscope (TEM). The results are shown in FIG. 7.

### Example 21

Powdery silica composite particles were obtained in the same manner as in Example 16, except for replacing 0.5 ml of ionic liquid A with 0.5 ml of ionic liquid F. As a result, the yield was 39 mass %, the P content 0.27 mass %, and the average particle size 143.01±25.6 nm. The powdery silica composite particles and, for comparison, silica powder (1) and ionic liquid F were analyzed by thermogravimetry. The results obtained are shown in FIG. 8. The weight losses of the powdery silica composite particles and the silica powder (1) at 800° C. were 7.7% and 8.2%, respectively.

### Example 22

Powdery silica composite particles were obtained in the same manner as in Example 16, except for replacing 0.5 ml of ionic liquid A with 0.5 ml of ionic liquid G. As a result, the yield was 56 mass %, the P content 0.29 mass %, and the average particle size 124.4±23.5 nm. The powdery silica composite particles and, for comparison, silica powder (1) and ionic liquid G were analyzed by thermogravimetry. The results obtained are shown in FIG. 9. The weight losses of the powdery silica composite particles and the silica powder (1) at 800° C. were 6.3% and 8.2%, respectively.

### Example 23

Powdery silica composite particles were obtained in the same manner as in Example 16, except for replacing 0.5 ml of ionic liquid A with 0.5 ml of ionic liquid H. As a result, the yield was 31 mass %, the P content 0.09 mass %, and the average particle size 114.2±29.0 nm. The powdery silica composite particles and, for comparison, silica powder (1) and ionic liquid H were analyzed by thermogravimetry. The results obtained are shown in FIG. 10. The weight losses of the powdery silica composite particles and the silica powder (1) at 800° C. were 4.8% and 8.2%, respectively.

### Comparative Example 1

In a 50 ml bottle were put 20 ml of methanol, and 0.5 ml of ionic liquid A, and 2.3 mmol of tetraethoxysilane (T0100 available from Tokyo Chemical Industry Co., Ltd.) were then added, followed by stirring to mix them. While thoroughly stirring, 3.8 g of 1N hydrochloric acid was added. The reaction system was stirred overnight and concentrated to solid, which was dispersed in methanol by stirring overnight, followed by centrifugation. The operation of dispersing the solid in methanol by stirring overnight, followed by centrifugation was repeated twice. The thus purified solid was dried in vacuo in a vacuum desiccator to give powdery silica composite particles. The yield was 83 mass %. The powdery silica composite particles were added to methanol and then dispersed in methanol by stirring for 24 hours to provide a sample (A). The average dispersed particle size of the sample (A) was 4.3±0.3 μm as measured with a particle size analyzer SALD-100S from Shimadzu Corp. The powdery silica composite particles and, for comparison, silica powder (2) were analyzed by thermogravimetry. As a result, the weight losses of the powdery silica composite particles and the silica powder (2) at 800° C. were 20.1% and 16.5%, respectively.

The analyzers and methods of analysis used in Examples and Comparative Example were as follows.

(a) ICP-AES: ICP-AES JY170C ULTRACE available from Horiba, Ltd.; measuring wavelength: 214.914 nm (emission line of P atom)
(b) Measurement of average particle size and particle size distribution: DLS-600HL available from Otsuka Electronics Co., Ltd.; dynamic light scattering method
(c) Thermogravimetry: BRUKER axs TG-DTA2000SA; atmospheric pressure
(d) Silica powder (1): In a 50 ml bottle was put 20 ml of methanol, and 3.33 g of the same silica sol as used in Example 16, and 2.3 mmol of tetraethoxysilane were then added, followed by mixing by stirring. While stirring thoroughly, 0.5 ml of 25% aqueous ammonia was added. The reaction system was stirred overnight and concentrated to solid, which was dispersed in methanol by stirring overnight, followed by centrifugation. The operation of dispersing the solid in methanol by stirring overnight, followed by centrifugation was repeated twice. The thus purified solid was dried in vacuo in a vacuum desiccator to give silica powder (1) for comparison.
(e) Silica powder (2): In a 50 ml bottle were put 20 ml of methanol and then 2.3 mmol of tetraethoxysilane, followed by mixing by stirring. While stirring thoroughly, 3.8 g of 1N hydrochloric acid was added. The reaction system was stirred overnight and concentrated to solid, which was dispersed in methanol by stirring overnight, followed by centrifugation. The operation of dispersing the solid in methanol by stirring overnight, followed by centrifugation was repeated twice. The thus purified solid was dried in vacuo in a vacuum desiccator to give silica powder (2) for comparison.

### BRIEF DESCRIPTION OF THE DRAWINGS

FIG. 1 is a particle size distribution of the powdery silica composite particles of Example 2.

FIG. 2 is a thermogram of Example 16.

FIG. 3 is a thermogram of Example 17.

FIG. 4 is a thermogram of Example 18.

FIG. 5 is a thermogram of Example 19.

FIG. 6 is a thermogram of Example 20.

FIG. 7 is a TEM image of Example 20.

FIG. 8 is a thermogram of Example 21.

FIG. 9 is a thermogram of Example 22.

FIG. 10 is a thermogram of Example 23.

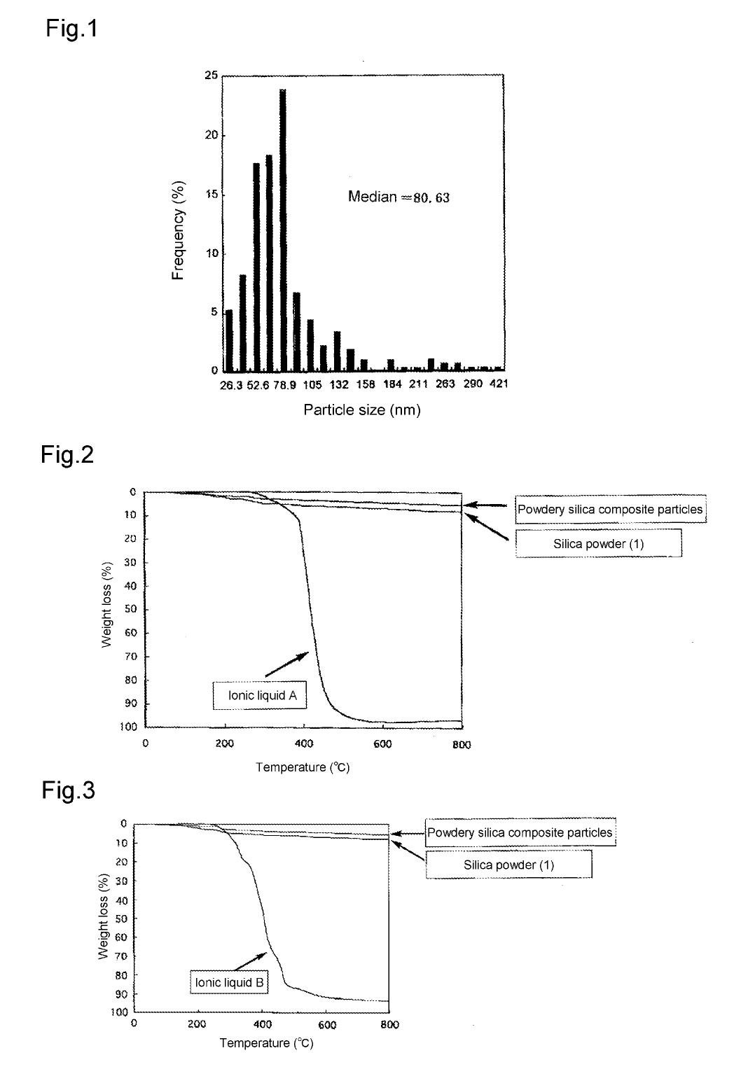

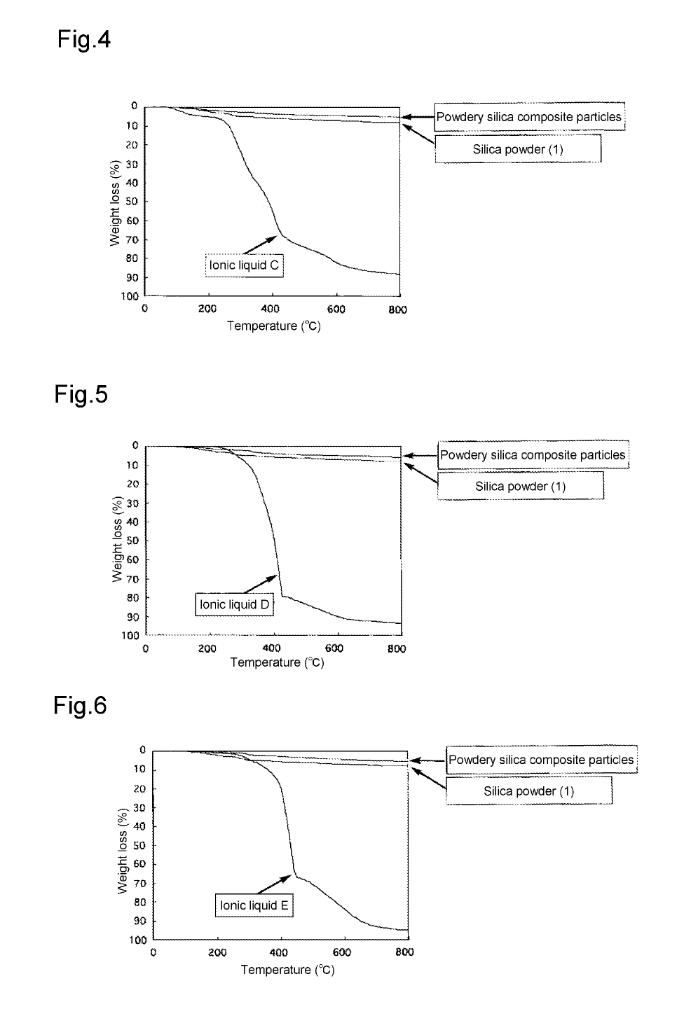

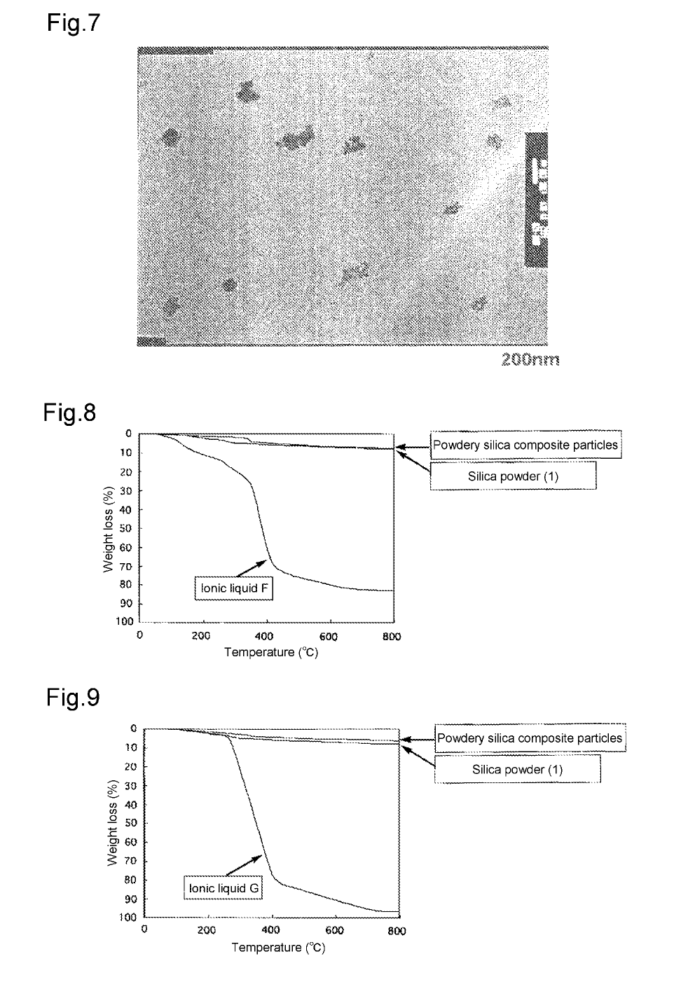

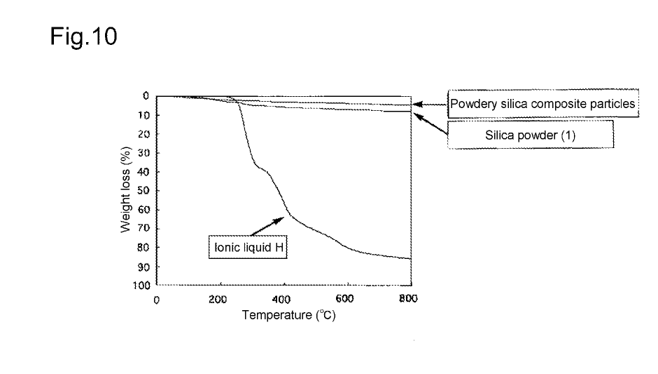

### INDUSTRIAL APPLICABILITY

The powdery silica composite particles of the present invention provide functional materials having an ionic liquid or a phosphonium salt of general formula (1) finely and uniformly dispersed therein.

1. A powdery silica composite particle obtained by a surface treatment step comprising providing a reaction solution by mixing a silica sol containing a core silica particle having an average particle size of 5 to 200 nm, an alkoxysilane, and an ionic liquid and hydrolyzing the alkoxysilane by addition of an acid or an alkali to the reaction solution to surface-treat the core silica particle.

2. A powdery silica composite particle obtained by a surface treatment step comprising providing a reaction solution by mixing a silica sol containing a core silica particle having an average particle size of 5 to 200 nm, an alkoxysilane, and a phosphonium salt represented by general formula (1): 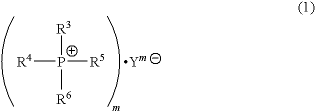
(wherein R³, R⁴, R⁵, and R⁶, which may be the same or different and may have part of the hydrogen atoms thereof substituted, each represent a straight-chain or branched alkyl group having 1 to 18 carbon atoms, a cycloalkyl group, or a phenyl group; m represents an integer 1 or 2; and Y represents an anion group)
and hydrolyzing the alkoxysilane by addition of an acid or an alkali to the reaction solution to surface-treat the core silica particle.

3. The powdery silica composite particle according to claim 1 or 2, wherein the reaction solution further contains a fluoroalkyl-containing oligomer represented by general formula (2): 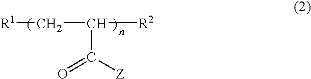
(wherein R¹ and R², which may be the same or different, each represent a —(CF₂)ₚ—X group or a —CF(CF₃)—[OCF₂CF(CF₃)]_{q}—OC₃F₇; X represents a hydrogen atom, a fluorine atom, or a chlorine atom; p and q each represent an integer of 0 to 10; Z represents a hydroxyl group, a morpholino group, a tertiary amino group, or a secondary amino group; and n represents an integer of 5 to 1000)

4. A powdery silica composite particle comprising a core silica particle and an ionic liquid supported on the core silica particle and having an average particle size of 5 to 900 nm.

5. A powdery silica composite particle comprising a core silica particle and a phosphonium salt represented by general formula (1): 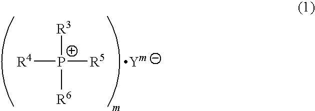
(wherein R³, R⁴, R⁵, and R⁶, which may be the same or different and may have part of the hydrogen atoms thereof substituted, each represent a straight-chain or branched alkyl group having 1 to 18 carbon atoms, a cycloalkyl group, or a phenyl group; m represents an integer 1 or 2; and Y represents an anion group)
supported on the core silica particle, the powdery silica composite particle having an average particle size of 5 to 900 nm.

6. A powdery silica composite particle comprising a core silica particle, an ionic liquid, and a fluoroalkyl-containing oligomer represented by general formula (2): 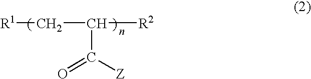
(wherein R¹ and R², which may be the same or different, each represent a —(CF₂)ₚ—X group or a —CF(CF₃)—[OCF₂CF(CF₃)]_{q}—OC₃F₇; X represents a hydrogen atom, a fluorine atom, or a chlorine atom; p and q each represent an integer of 0 to 10; Z represents a hydroxyl group, a morpholino group, a tertiary amino group, or a secondary amino group; and n represents an integer of 5 to 1000)
both the ionic liquid and the fluoroalkyl-containing oligomer being supported on the core silica particle, the powdery silica composite particle having an average particle size of 5 to 900 nm.

7. A powdery silica composite particle comprising a core silica particle, a phosphonium salt represented by general formula (1): 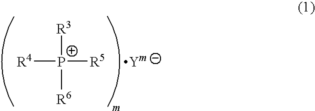
(wherein R³, R⁴, R⁵, and R⁶, which may be the same or different and may have part of the hydrogen atoms thereof substituted, each represent a straight-chain or branched alkyl group having 1 to 18 carbon atoms, a cycloalkyl group, or a phenyl group; m represents an integer 1 or 2; and Y represents an anion group)
and a fluoroalkyl-containing oligomer represented by general formula (2):
(wherein R¹ and R², which may be the same or different, each represent a —(CF₂)ₚ—X group or a —CF(CF₃)—[OCF₂CF(CF₃)]_{q}—OC₃F₇;
X represents a hydrogen atom, a fluorine atom, 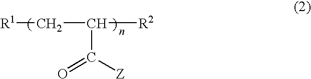
or a chlorine atom; p and q each represent an integer of 0 to 10; Z represents a hydroxyl group, a morpholino group, a tertiary amino group, or a secondary amino group; and n represents an integer of 5 to 1000)
both the phosphonium salt and the fluoroalkyl-containing oligomer being supported on the core silica particle, the powdery silica composite particle having an average particle size of 5 to 900 nm.

8. A powdery silica composite particle comprising a core silica particle and a silica coating film formed on the core silica particle, the silica coating film containing an ionic liquid, the powdery silica composite particle having an average particle size of 5 to 900 nm.

9. A powdery silica composite particle comprising a core silica particle and a silica coating film formed on the core silica particle, the silica coating film containing a phosphonium salt represented by general formula (1): 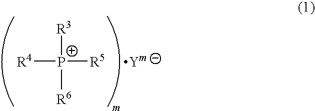
(wherein R³, R⁴, R⁵, and R⁶, which may be the same or different and may have part of the hydrogen atoms thereof substituted, each represent a straight-chain or branched alkyl group having 1 to 18 carbon atoms, a cycloalkyl group, or a phenyl group; m represents an integer 1 or 2; and Y represents an anion group)
the powdery silica composite particle having an average particle size of 5 to 900 nm.

10. The powdery silica composite particle according to claim 8 or 9, wherein the silica coating film further contains a fluoroalkyl-containing oligomer represented by general formula (2): 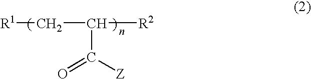
(wherein R¹ and R², which may be the same or different, each represent a —(CF₂)ₚ—X group or a —CF(CF₃)—[OCF₂CF(CF₃)]_{q}—OC₃F₇; X represents a hydrogen atom, a fluorine atom, or a chlorine atom; p and q each represent an integer of 0 to 10; Z represents a hydroxyl group, a morpholino group, a tertiary amino group, or a secondary amino group; and n represents an integer of 5 to 1000)

11. A process of producing a powdery silica composite particle comprising a surface treatment step comprising substeps of providing a reaction solution by mixing a silica sol containing a core silica particle having an average particle size of 5 to 200 nm, an alkoxysilane, and an ionic liquid and hydrolyzing the alkoxysilane by addition of an acid or an alkali to the reaction solution to surface-treat the core silica particle.

12. A process of producing a powdery silica composite particle comprising a surface treatment step comprising the substeps of providing a reaction solution by mixing a silica sol containing a core silica particle having an average particle size of 5 to 200 nm, an alkoxysilane, and a phosphonium salt represented by general formula (1): 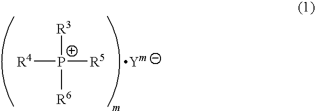
(wherein R³, R⁴, R⁵, and R⁶, which may be the same or different and may have part of the hydrogen atoms thereof substituted, each represent a straight-chain or branched alkyl group having 1 to 18 carbon atoms, a cycloalkyl group, or a phenyl group; m represents an integer 1 or 2; and Y represents an anion group)
and hydrolyzing the alkoxysilane by addition of an acid or an alkali to the reaction solution to surface-treat the core silica particle.

13. The process of producing a powdery silica composite particle according to claim 11 or 12, wherein the reaction solution further contains a fluoroalkyl-containing oligomer represented by general formula (2): 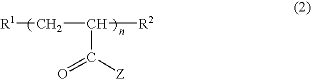
(wherein R¹ and R², which may be the same or different, each represent a —(CF₂)ₚ—X group or a —CF(CF₃)—[OCF₂CF(CF₃)]_{q}—OC₃F₇; X represents a hydrogen atom, a fluorine atom, or a chlorine atom; p and q each represent an integer of 0 to 10; Z represents a hydroxyl group, a morpholino group, a tertiary amino group, or a secondary amino group; and n represents an integer of 5 to 1000)

14. A silica composite particle dispersion comprising a solvent and the silica composite particle according to any one of claims 1, 2 or 4-9 dispersed in the solvent.

15. A resin composition comprising the silica composite particle according to any one of claims 1, 2, or 4-9.
